(19) United States
(12) Patent Application Publication
(10) Pub. No.: US 2016/0109185 A1
(43) Pub. Date: Apr. 21, 2016

(54) ENERGY STORAGE SYSTEM

(71) Applicants: ROLLS-ROYCE POWER ENGINEERING PLC, Derby (GB); ROLLS-ROYCE PLC, London (GB)

(72) Inventors: Michael MIDDLETON, Lymm (GB); Robert COLLINS, Derby (GB)

(21) Appl. No.: 14/867,849

(22) Filed: Sep. 28, 2015

(30) Foreign Application Priority Data
Oct. 16, 2014 (GB) 1418356.0
May 6, 2015 (GB) 1507734.0

(51) Int. Cl. F28D 20/00; G21C 15/24

(52) U.S. Cl. CPC F28D 20/0034; G21C 15/24

(57) ABSTRACT

Energy storage system regulating power output of a power generation plant that has a heat exchanger, primary circuit and secondary circuit, primary circuit directs primary fluid flow to components of a primary region and secondary circuit directs a secondary fluid flow to components of a secondary region, the heat exchanger is arranged so the secondary fluid flow is heated from the primary fluid flow. Energy storage arrangement makes a vessel for storing secondary fluid. Fluid transfer arrangement connects the vessel and is connectable to the heat exchanger of the power generation system to arrange the fluid transfer arrangement in fluid communication with the heat exchanger and the vessel. Bidirectional flow arrangement configured to control flow direction of fluid between the vessel and fluid transfer arrangement to selectively store heat energy from the heat exchanger in the vessel, and selectively transfer heat energy stored in the vessel to the heat exchanger.

### FIELD OF INVENTION

The present invention relates to an energy storage system and/or a power plant for example a nuclear power plant and/or a method of modifying the power output of a power generation system.

### BACKGROUND

The use of low carbon generating power systems such as renewable power and nuclear power is increasing. However, the power output from such systems is often either intermittent or where it is constant it can be difficult and/or inefficient to alter the power output to account for varying demand. For example, a nuclear power plant is generally most efficient when it is running at 100% rated power, and as such it is generally undesirable to reduce the power rating of a nuclear power plant to account for varying demand.

One way to provide a low carbon generating power system that adapts to the loading demands is to use electricity storage. Generally it is desirable for an electricity storage arrangement to meet the following criteria:
(1) Harvest and store surplus electricity generated
(2) Address inter-season variation in electricity demand
(3) Address diurnal variation in electricity demand
(4) Maintain a fast response “surge power” capability

Furthermore, there is a desire in the industry for the capital cost and the running cost of the energy storage system to be low.

### SUMMARY

The present disclosure seeks to provide an energy storage system that meets one or more of the above mentioned criteria.

A first aspect provides an energy storage system for regulating power output of a power generation plant that has a heat exchanger, a primary circuit and a secondary circuit, the primary circuit directs a primary fluid flow to components of a primary region and the secondary circuit directs a secondary fluid flow to components of a secondary region, and the heat exchanger is arranged so that the secondary fluid flow is heated from the primary fluid flow. The energy storage system comprises a vessel for storing fluid.

The energy storage system may comprise a fluid transfer arrangement (for example a tertiary fluid circuit) connected to the vessel and connectable to the heat exchanger of the power generation system so as to arrange the fluid transfer arrangement in fluid communication with the heat exchanger and the vessel. The energy storage system may comprise a bidirectional flow arrangement configured to control a flow direction of fluid between the vessel and the fluid transfer arrangement.

The bidirectional flow arrangement can be configured so as to selectively store heat energy from secondary fluid exiting the heat exchanger in the vessel, and to selectively transfer heat energy stored in the vessel to the heat exchanger

The bidirectional flow arrangement may comprise a bidirectional pumping arrangement.

The bidirectional flow arrangement may comprise a valve arrangement for selectively blocking flow along a portion of the fluid transfer arrangement.

The vessel may store fluid, e.g. secondary fluid.

The secondary fluid exiting the heat exchanger may exit the heat exchanger at a temperature equal to or between about 280 to 300° C. The secondary fluid entering the heat exchanger may enter the heat exchanger at a temperature equal to or between about 260 to 275° C. Secondary fluid may be added to the fluid transfer arrangement (e.g. from a feed water heater) at a temperature equal to or between about 200 and 220° C.

The fluid transfer arrangement may be connectable to a secondary fluid inlet of the heat exchanger. The fluid transfer arrangement may be connectable to a secondary fluid outlet of the heat exchanger.

The fluid transfer arrangement may include a heat transfer arrangement for transferring heat energy from the secondary fluid exiting the heat exchanger to secondary fluid at a lower temperature than the fluid exiting the heat exchanger, and/or for transferring heat energy from secondary fluid stored in the vessel to a secondary fluid at a lower temperature than the fluid stored in the vessel. The fluid transfer arrangement may comprise a saturator configured to heat a first fluid using a second fluid. For example, a saturator configured to heat lower temperature secondary fluid using higher temperature fluid from the heat exchanger or from the vessel.

The saturator may include a tank having a first inlet for receiving secondary fluid at a lower temperature than the fluid exiting the heat exchanger, and a second inlet for receiving secondary fluid exiting the heat exchanger. The tank may be arranged so that the fluid from the heat exchanger can directly contact the lower temperature fluid.

The saturator may include a heat exchanger defining a first fluid pathway for receiving fluid at a lower temperature than the fluid exiting the heat exchanger and a second fluid pathway for receiving secondary fluid from the heat exchanger, the first fluid pathway being positioned adjacent the second fluid pathway.

The bidirectional flow arrangement may be configured so as to selectively direct a portion of the secondary fluid exiting the heat exchanger of the power plant to the heat transfer arrangement such that the secondary fluid is the second fluid that heats the first fluid.

The bidirectional flow arrangement may be configured so as to selectively direct fluid from the vessel directly to the heat exchanger and/or to selectively direct fluid from the vessel to the saturator to heat a fluid to be directed to the heat exchanger.

Alternatively, the fluid transfer arrangement may be configured to transfer fluid from the vessel to the heat exchanger of the power plant.

The bidirectional flow arrangement may be provided between the saturator and the vessel.

The bidirectional flow arrangement may be a bidirectional pumping arrangement provided between the saturator and the vessel.

A conduit may be provided between the saturator and the vessel and a first two-way pump may be positioned along said conduit. A further conduit may be provided between the saturator and the vessel and a second two-way pump may be positioned along said further conduit.

The direction of flow of fluid may be controlled using a plurality of valves.

A pump may be provided and in examples two pumps may be provided so as to regulate a steady flow rate.

A valve arrangement may be provided to control the volume of fluid flow from the heat exchanger of the power plant to the saturator.

The energy storage system may comprise a pump provided between the saturator and the heat exchanger of the power plant.

The vessel may be configured to store secondary fluid.

The fluid transfer arrangement may comprise a first conduit connected to the vessel and connectable to the heat exchanger of the power generation system so as to arrange the vessel in fluid communication with the heat exchanger.

A first conduit may be connected to the vessel and may be connectable to the heat exchanger of the power generation system so as to arrange the vessel in fluid communication with the heat exchanger. A bidirectional pumping arrangement may be configured to control a flow of fluid to the vessel from the heat exchanger of the power generation plant and from the vessel to the heat exchanger of the power generation plant.

The flow of fluid from the vessel to the heat exchanger can increase the power output of the power generation plant and the flow of fluid from the heat exchanger to the vessel can decrease the power output of the power generation plant. In this way, the power output from a power generation plant can be varied without the need to modify a primary energy source of the power plant (e.g. without the need to change the amount of heat energy produced in a nuclear reactor).

In the present application, the primary circuit and the secondary circuit are considered to be the pipes that connect various components of a respective primary region and secondary region of a power generation plant. In a nuclear power plant, the primary region may include the nuclear reactor and pumps. The secondary region may include turbines, a condenser (including a condenser hotwell), one or more water heaters and one or more pumps. The heat exchanger, which may be a steam generator, forms part of both the primary region and the secondary region.

The system may be considered to comprise a siphon for siphoning fluid from the vessel to the heat exchanger and/or for siphoning fluid from the heat exchanger to the vessel.

A second conduit may be connected to the vessel. The second conduit may be connectable to the secondary circuit at a position upstream of the heat exchanger so as to arrange the vessel in fluid communication with the secondary circuit.

The first conduit may be provided at one end of the vessel. The second conduit may be provided at one end of the vessel. The second conduit may be provided at an opposite end of the vessel to the first conduit. For example, when the vessel is orientated in an operating position, the first conduit may be provided in an upper region or at an upper end of the vessel and the second conduit may be provided in a lower region or at a lower end of the vessel.

The pumping arrangement may be arranged along the second conduit and the pumping arrangement may be configured to control flow there along. For example, the pumping arrangement may be configured to pump fluid to the vessel so as to displace fluid from the vessel to the heat exchanger and the pumping arrangement may be configured to pump fluid from the vessel to divert fluid from the heat exchanger to the vessel.

The bidirectional pumping arrangement may be configured to pump a larger flow rate of fluid from the secondary circuit to the vessel than from the vessel to the secondary circuit. For example, the fluid flow rate to the vessel may be one third of the fluid flow rate through the secondary fluid flow. The fluid flow rate from the vessel may be 10% of the fluid flow rate through the secondary fluid flow.

The vessel may include an arrangement for limiting mixing of hotter fluid from the heat exchanger or saturator with cooler fluid from the secondary fluid flow and/or saturator.

The vessel may include a baffle that in use limits mixing of hotter fluid from the heat exchanger or saturator with cooler secondary fluid (e.g. from a feed water heater and/or saturator).

The baffle may include a serpentine path along which secondary fluid can flow in the vessel. The baffle may include a plurality of plates that extend across the vessel. In use, the plates may be orientated horizontally.

The vessel may comprise an inlet configured for attachment to a supply of nitrogen gas. The inlet may be positioned proximal to the first conduit and distal to the second conduit.

The system may comprise an overflow tank for storing excess fluid from the vessel so as to regulate the volume of fluid in the vessel.

The system may comprise a top-up tank for providing a supply of fluid to the vessel so as to regulate the volume of the fluid in the vessel. The top-up tank may be provided in direct fluid communication with the vessel.

The vessel may be a pressurised vessel capable of containing fluid at a pressure greater than or equal to 50 bar.

The vessel may be spherical. The pressure vessel may have a stainless steel liner. The pressure vessel may be surrounded by concrete. The pressure vessel may be insulated, e.g. insulation may be provided between the steel liner and the concrete.

The heat exchanger of the power generation plant may be a steam generator and the first conduit may connect directly to the steam generator. The first conduit may connect (and/or penetrate) the steam generator at a position corresponding to a region of the steam generator that in use contains saturated water. For example, the first conduit may connect to the steam generator in a region mid-way between the secondary fluid inlet and the outlet of steam generator.

The bidirectional pumping arrangement may comprise two pumps. A first pump may be for pumping flow from the vessel and a second pump may be for pumping flow to the vessel. A switching arrangement may be provided to selectively operate either the first or the second pump. The switching arrangement may include a timer e.g. to switch between the first and second pumps at a predetermined time of day.

The system may be configured for use with a nuclear power plant.

The system may comprise a valve positioned between the steam generator and the vessel and operable to divert fluid from the vessel to the steam generator in the event of power plant blackout.

The valve may be a solenoid valve.

A fluid circuit may be connected to the vessel and may be connectable to the heat exchanger. The fluid circuit may comprise a saturator for transferring heat energy from one fluid to another. The fluid circuit may be configured to direct fluid exiting the heat exchanger to the saturator, direct fluid from the saturator to an inlet of the heat exchanger, to direct fluid flow to the vessel from the saturator, and to direct fluid flow to the saturator and/or the heat exchanger from the vessel

A second aspect of the disclosure provides a nuclear power plant comprising a reactor; a primary fluid flow for cooling the reactor; a steam generator; a secondary fluid flow that is heated by the primary fluid flow in the steam generator; a power generator powered by the secondary fluid heated in the steam generator; and an energy storage system according to the first aspect.

The first conduit or fluid transfer arrangement of the energy storage system may connect to the steam generator in a region of the steam generator where, in use, the secondary fluid is at approximately saturation temperature.

A third aspect of the disclosure provides a power generation plant comprising the energy storage system according to the first aspect.

The plant of the second or third aspect may comprise a waste heat management system.

A fourth aspect provides a nuclear power plant comprising a reactor; a primary fluid flow for cooling the reactor; a steam generator; a secondary fluid flow that is heated by the primary fluid flow in the steam generator; and a power generator powered by the secondary fluid heated in the steam generator. A fluid circuit is provided and comprises a saturator and a vessel. The fluid circuit is arranged to supply the steam generator with secondary fluid and to selectively divert at least a portion of the steam exiting the steam generator to the saturator. The fluid circuit is arranged to supply the vessel with fluid from the saturator

A fifth aspect of the disclosure provides a method of modifying the power output of a power generation system, the power generation system comprising a heat exchanger for heating a secondary fluid from a primary fluid. The method comprises providing a storage vessel and a first conduit connecting the vessel to the heat exchanger; and controlling the flow of fluid between the heat exchanger and the vessel to regulate power generation.

A sixth aspect of the disclosure provides a method of modifying the power output of a power generation system. The power generation system comprising a heat exchanger for heating a secondary fluid from a primary fluid. The method comprises selectively diverting a portion of the secondary fluid exiting the heat exchanger to an energy storage system. The method further comprises storing the secondary fluid from the heat exchanger in a vessel, or using the secondary fluid from the heat exchanger to heat a fluid that is then stored in a vessel.

The method may comprise selectively diverting fluid from the vessel to the heat exchanger, or using fluid from the vessel to heat a fluid that is then diverted to the heat exchanger.

The method may comprise providing the energy storage system of the first aspect.

The heat exchanger may be a steam generator and the fluid in the vessel may be at a similar (e.g. substantially equal) pressure to the secondary fluid in the steam generator.

The fluid may be stored in the vessel at saturation pressure and temperature. The energy storage system may be arranged to avoid boiling of the secondary fluid.

To increase the power output of the power plant, secondary fluid may be pumped to the vessel from the secondary fluid flow at a position downstream of the heat exchanger so as to cause a flow of fluid from the vessel to the heat exchanger.

To decrease the power output of the power plant, fluid may be pumped from the vessel to the secondary fluid flow so as to cause a flow of fluid from the heat exchanger to the vessel.

### DESCRIPTION OF DRAWINGS

The invention will now be described, by way of example only, with reference to the accompanying drawing in which:

FIG. 1 illustrates a schematic arrangement of a nuclear power plant having an energy storage system;

FIG. 2 illustrates a schematic arrangement of a nuclear power plant having an alternative energy storage system;

FIG. 3 illustrates operation of the energy storage system of FIG. 2 during charge;

FIG. 4 illustrates operation of the energy storage system of FIG. 2 during discharge; and

FIG. 5 illustrates a schematic arrangement of a nuclear power plant having a further alternative energy storage system.

### DETAILED DESCRIPTION

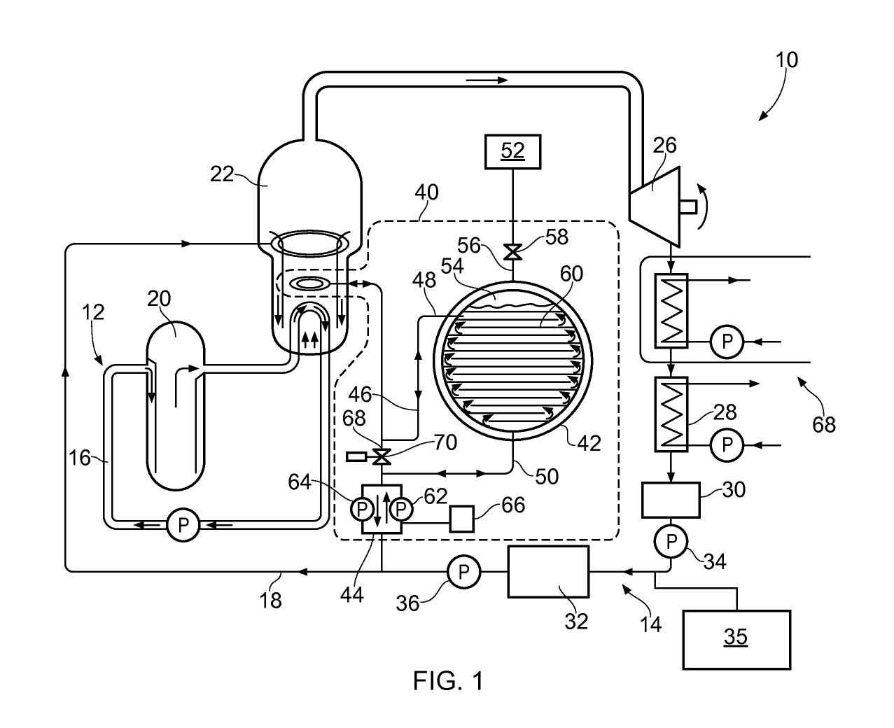

Referring to FIG. 1, a nuclear power plant is indicated generally at 10. The nuclear power plant includes a primary region 12 and a secondary region 14. The primary region includes a primary circuit 16 around which a primary fluid flows. The secondary region includes a secondary circuit 18 about which a secondary fluid flows. In the present embodiment the primary fluid and the secondary fluid is water (liquid or steam depending on the position in the relevant flow path).

The primary region 12 further includes a nuclear reactor 20 that heats the primary fluid flow. The primary circuit 16 is arranged to direct fluid to the nuclear reactor, from the nuclear reactor to a steam generator 22 and then back to the nuclear reactor. A pump 24 is configured to pump the primary fluid around the primary circuit. The reactor may be any suitable reactor type, the types of which are known to the person skilled in the art so will not be explained in more detail here. In exemplary embodiments, the reactor 20 may be a small modular reactor. In exemplary embodiments, in use, the primary fluid may be at a pressure of approximately 155 bar. In exemplary embodiments, in use, the primary fluid exiting the reactor and upstream of the steam generator may be at a temperature of approximately 315° C., and the primary fluid exiting the steam generator and upstream of the reactor may be at a temperature of approximately 275° C.

The steam generator 22 is arranged to receive a flow of secondary fluid, so that in use the primary fluid heats the secondary fluid. The secondary circuit 18 is arranged to direct hot secondary fluid flow from the steam generator to one or more turbines 26.

The secondary fluid powers the turbines which are usually connected to a generator to generate electricity. In exemplary embodiments, in use, the secondary fluid may be at a pressure of approximately 62 bar. In use, secondary fluid upstream of the steam generator and downstream of the heater 32 may be at a temperature of approximately 220° C., and secondary fluid downstream of the steam generator and upstream of the turbines may be at a temperature of approximately 275° C. When the secondary fluid is water, the secondary fluid exiting the steam generator may be steam.

The steam generator of the present embodiment is of the tube and shell type, in particular a U-tube steam generator. However, in alternative embodiments the steam generator may have an alternative configuration, for example it may be a Heat

Recovery Steam Generator (HRSG) or a once through steam generator (OTSG). The steam generator may be of substantially conventional design, but as will become apparent later, the steam generator may be modified to include one or more connections to an energy storage system.

The secondary circuit 18 directs fluid flow from the turbines 26 to a condenser 28 and then to a condenser hotwell 30. From the condenser hotwell, the secondary circuit directs fluid flow to a heater 32. The secondary fluid circuit then directs the secondary fluid back to the steam generator 22. One or more pumps 34, 36 are provided to in use, pump the secondary fluid around the secondary circuit.

A cold feed fluid storage tank 35 is provided to provide a “top up” to the fluid in the secondary circuit when required. Surplus fluid in the secondary circuit can be extracted from the condenser hotwell and returned to the storage tank 35. As will be later described, the plant of FIG. 1 includes an energy storage system that utilises fluid from the secondary circuit, and as such the storage tank 35 may be larger than storage tanks that may be otherwise conventionally provided.

The nuclear power plant 10 includes an energy storage system, indicated by dotted line 40 in FIG. 1.

The energy storage system 40 includes a storage vessel 42 and a bidirectional pumping arrangement 44. A tertiary circuit 46 connects the bidirectional pump arrangement 44 to the secondary circuit 18, the pump arrangement 44 to the storage vessel 42, and the storage vessel 42 to the steam generator 22.

A first conduit 48 of the tertiary circuit 46 connects the storage vessel 42 to the steam generator 22. The first conduit connects to the vessel in an upper region of the vessel. A second conduit 50 connects the vessel to the secondary fluid circuit 18 at a position upstream of the steam generator 22. The second conduit 50 connects to the vessel in a lower region of the vessel.

The first conduit 48 is configured to penetrate the steam generator in a region of saturated (but not boiling) fluid. The temperature of the secondary fluid in the steam generator increases from the steam generator inlet to the steam generator outlet. The steam generator may be considered as having four regions, a first region of relatively cold water, a second region of saturated water, a third region of two phase steam and water and a fourth region of steam which exits the steam generator and flows to the turbine.

A nitrogen gas source 52 is provided. In use nitrogen gas is supplied to the vessel 42 to provide a nitrogen gas blanket 54 on the surface of the fluid in the vessel 42. A third conduit is provided in an upper region of the vessel for directing Nitrogen gas from the nitrogen gas source to the vessel. A valve 58 is provided to control the flow of nitrogen gas to the vessel and/or to close the third conduit so that the nitrogen can be detached if required.

The storage vessel 42 is a pressurised vessel. The vessel is spherical. The vessel includes a stainless steel liner and a concrete outer. An insulating material may be provided between the liner and concrete. The vessel is arranged so as to discourage mixing of fluid in a vertical direction (in use and as shown in FIG. 1), e.g. to discourage mixing of fluid in a direction extending from the region of connection with the second conduit 50 to the region of connection with the first conduit 48. In the present embodiment, mixing of fluid is discouraged in a vertical direction by the provision of a baffle 60. The baffle includes a plurality of plates that extend across the diameter of the vessel. In the present embodiment, when the vessel is installed the plates extend horizontally across the vessel. The provision of the plates provides a serpentine path for the secondary fluid to flow. In use, the secondary fluid flows from the lower region of the vessel to the upper region of the vessel along the serpentine path.

Fluid flow to and from the vessel 42 is controlled by the pump arrangement 44. The pump arrangement 44 includes two pumps 62 and 64. One of the pumps 62 is configured to pump fluid to the vessel 42 and the other of the pumps 64 is configured to pump fluid from the vessel 42. The pump 62 configured to pump fluid to the vessel is arranged to pump a larger flow rate of fluid to the vessel than the flow rate of fluid pumped from the vessel by the pump 64 (when the pump 64 is activated). It is intended that only one of the pumps 62, 64 operates at a given time. A switching arrangement 66 may be provided to switch between the operation of pump 62 and the operation of pump 64. The switching arrangement may be configured to switch pumps at a time that coincides with an estimated change in peak demand.

The first conduit and the second conduit are connected by an intermediate conduit 68. A valve 70 is provided to selectively block the intermediate conduit during normal operation of the power plant 10. In the case of nuclear plant black out the valve 70 is operable to open and permit a flow of secondary fluid to the steam generator.

The power plant 10 further includes a waste heat recovery system 68. The waste heat recovery system is positioned downstream of the turbines 26 and upstream of the condenser 28. The secondary circuit 18 directs secondary fluid flow from the turbines 26 to a heat exchanger of the waste heat recovery system. A further fluid flow is pumped to the heat exchanger where it is heated by the secondary fluid flow, the further fluid flow is then extracted for heating.

The operation of the nuclear power plant 10 and in particular the energy storage system 40 will now be described.

Nuclear reactors are generally most efficient when they are running continuously at 100% rated power. The energy storage system 40 permits the nuclear reactor to run at constant thermal power output, but the electrical power output from the power plant to be varied with demand.

The general intended operation of the energy storage system 40 is that the secondary fluid at or close to saturation pressure and temperature is accumulated in the pressure vessel 42. The energy storage system should be arranged to avoid fluid boiling in the vessel 42. During times of increased loading (i.e. when the demand for power is increased), fluid from the pressure vessel can be directed to the steam generator to increase the steam output and therefore the electrical power output. During times of reduced loading, fluid heated in the steam generator can be directed to the pressure vessel for later use during periods of high loading. During the operation of the nuclear power plant 10, the reactor operates at 100% thermal power rating.

A nitrogen gas blanket is maintained in the upper region of the tank on the surface of the secondary fluid and is at a pressure substantially equal to the pressure of the secondary fluid in the steam generator 22.

During periods of increased loading, the pump 62 is activated to pump fluid from the secondary circuit 18 to the vessel 42. In the present embodiment, approximately a third of the secondary fluid from the pump 36 is diverted from the secondary circuit 18 to the vessel 42. The flow of secondary fluid into the vessel 42 displaces fluid in the upper region of the vessel 42 causing the fluid to flow to the steam generator through the first conduit 48 (for example the fluid could be considered as being siphoned from the vessel 42 to the steam generator). The displaced fluid is near saturation temperature, e.g. in the present embodiment where the secondary fluid is water, approximately 275° C. However, it will be appreciated that the saturation temperature will depend upon the operating pressure of the steam generator. The operating pressure of the steam generator is dependent upon the plant design in which the steam generator is used. The flow of displaced fluid from the vessel to the steam generator results in an increase in enthalpy of the body of fluid (i.e. the flow from the secondary circuit 18 and the displaced flow from the vessel which may be referred to as feedwater) flowing to the steam generator. The increased enthalpy of the body of fluid (or feedwater) results in an increased rate of steam generation, and as such the power generated via the turbine is increased, with no adjustment to the reactor 20.

As will be appreciated by the person skilled in the art, towards the end of the period of increased loading, there will be an increased volume of cooler fluid (at approximately 220° C.) than hotter fluid (at approximately 275° C.) in the vessel. The baffle 60 limits the mixing of the hotter and colder fluid in the vessel. The increase in volume of cooler fluid means that the interface between the zones of cooler and hotter fluid moves towards the upper region of the tank during the period of increased loading.

During a period of low loading, the pump 62, described previously as diverting fluid to the vessel 42, is switched off and the pump 64 is activated. The pump 64 is arranged to pump fluid from the vessel to the secondary circuit 18. The pump 64 pumps a smaller flow rate of fluid than pump 62. In the present embodiment, approximately 10% of the fluid flow through the secondary circuit is fluid that has been directed from the vessel to the secondary circuit. The displacement of fluid from the vessel causes fluid from the steam generator to flow to the vessel (for example fluid from the steam generator could be considered to be siphoned from the vessel). When a period of low loading follows a period of high loading, the pump 64 is directing cooler fluid from the vessel so that hotter fluid (e.g. fluid at or near saturation pressure and temperature) can be directed to the vessel. As will be appreciated by the person skilled in the art, the flow of fluid from the steam generator to the vessel and from the vessel to the secondary circuit increases the volume of hotter fluid in the vessel and moves the interface between the hotter fluid and the cooler fluid zones to a lower region of the tank. Thus, the energy storage system is again ready for a high loading period.

During the low loading period, fluid flowing from the steam generator to the storage vessel results in a reduction in the enthalpy of the body of water (or feedwater) entering the steam generator. As such, the volume of steam produced is reduced and as such the power generated is reduced. This reduction in power generation is possible without altering the reactor 20 conditions.

An example utilisation of the nuclear power plant 10 could be as follows. The plant may be nominally rated at for example 200 MWe (approximately 600 MW thermal). For 18 hours of a day, e.g. from 2200 until 1600, the plant could be configured to output 90% of the nominal capacity. The remaining capacity can be used to accumulate saturated fluid in the vessel 42. For 6 hours of the day, e.g. from 1600 to 2200 the plant could be configured to output 130% nominal capacity.

As will be apparent from the described example, an advantage of the energy storage system 40 is that the power plant 10 can be modified to change its power output to meet peak diurnal demand, whilst optimising efficiency by continuing to run the reactor at 100% power rating.

The plant 10 includes a waste heat recovery system. The peak electricity demands often coincide with peak heat demand, so the energy storage system 40 also helps to meet fluctuations in heat demand.

The plant 10 may be used as a reserve of energy to meet energy demands when these cannot be met by other means, e.g. other nuclear power plants, renewables or fossil fuels.

The energy storage system 40 can also be utilised after a station blackout. The vessel 42 provides a reservoir of fluid that can be used to recharge the steam generator. In the case of a station blackout all the electrics will be lost so the pumped flow is lost. The reactor trips and is shut down. The valve 70 is opened to allow fluid flow from the vessel 42 to the steam generator. The fluid flow in the steam generator cools the primary fluid. Decay heat is absorbed by the steam generator, causing the temperature and pressure of the fluid in the steam generator to rise. The rise in pressure causes a pressure relief valve on the steam generator to lift. By periodically releasing steam from the steam generator and reducing the steam generator pressure, the pressure of the nitrogen gas blanket (i.e. similar pressure to the secondary fluid of the steam generator during normal operating conditions, e.g. 62 bar) in the upper region of the vessel will continue to displace fluid from the vessel into the steam generator. This managed bleed and feed can increase the period before the steam generator boils dry.

The described energy storage system is one arrangement that can be used to control the output of a power generation plant. The following describes further optional energy storage systems. Similar reference numerals are given for similar features but with a prefix of “1” or “2” to distinguish between embodiments. Only the differences between the arrangements will be described.

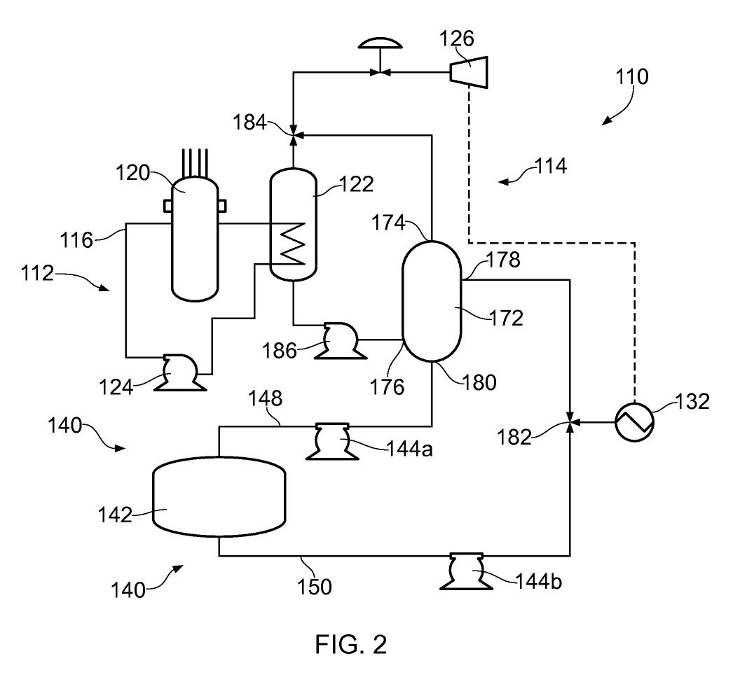

Referring to FIG. 2, an alternative energy storage system is indicated generally at 140. In the example of FIG. 2, the arrangement is similar to that of FIG. 1 but the energy storage system includes a saturator 172, e.g. it may be considered that there is a tertiary circuit that includes the saturator along what in the previous example were referred to as the primary and secondary conduits. Furthermore, the tertiary circuit is integrated to a greater degree into the secondary circuit than in the example of FIG. 1, that is the tertiary circuit is provided as part of the secondary circuit rather than simply being connected to it.

The energy storage system 140 includes a vessel 142 that is of similar construction to the vessel previously described. The energy storage system further includes a heat transfer arrangement, in this case a saturator 172, positioned between the vessel 140 and the steam generator 122. The provision of the saturator 172 means that the flow through the steam generator is a continuous steady flow, which reduces the variation in temperature and flow rate through the steam generator. This is particularly advantageous in the nuclear power industry, because it reduces the risk of reactor spikes that can be caused if the unsteady conditions of the secondary fluid are fed back to the primary fluid.

In the present example the saturator is a direct saturator. The saturator includes a tank having an inlet 174, an outlet 176, a further inlet 178 and a port 180 that can operate as an inlet or an outlet. The tank is arranged so as to allow mixing of the fluids from the inlets (and/or port when applicable) before the exiting the tank via the outlet or port (as applicable).

A conduit is connected to the inlet 174 and is arranged such that the steam generator 122 is in fluid communication with the saturator 172 via said conduit. A valve arrangement 184 is provided so as to selectively control the volume of secondary fluid diverted to the saturator from the steam generator. A further conduit is connected to the outlet 176 and is arranged such that the steam generator is in fluid communication with the saturator via said conduit.

A conduit is provided between the vessel 142 and the port 180 of the saturator 172. The conduit is connected to the vessel at a position towards the top of the vessel 142. A further conduit is connected to the vessel at a position towards the bottom of the vessel. The further conduit connects between the vessel and the inlet 178 of the saturator.

A two-way pump 144a is provided between the vessel 142 and the port 180 of the saturator 172, and a further two-way pump 144b is provided between the vessel 142 and the inlet 178 of the saturator.

A valve arrangement 182 is provided along the conduit between the vessel 142 and the inlet 178 of the saturator 172. The valve arrangement can be operated to allow feed water from the heater 132 to be provided to the conduit, and/or for a region of the conduit to be fully or partially closed.

A one-way pump 186 is provided between the saturator 172 and the steam generator.

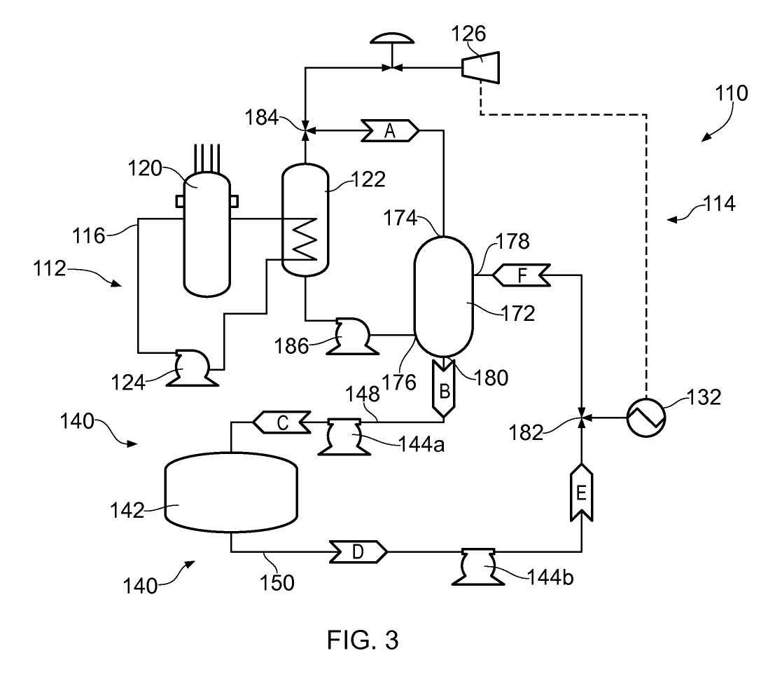

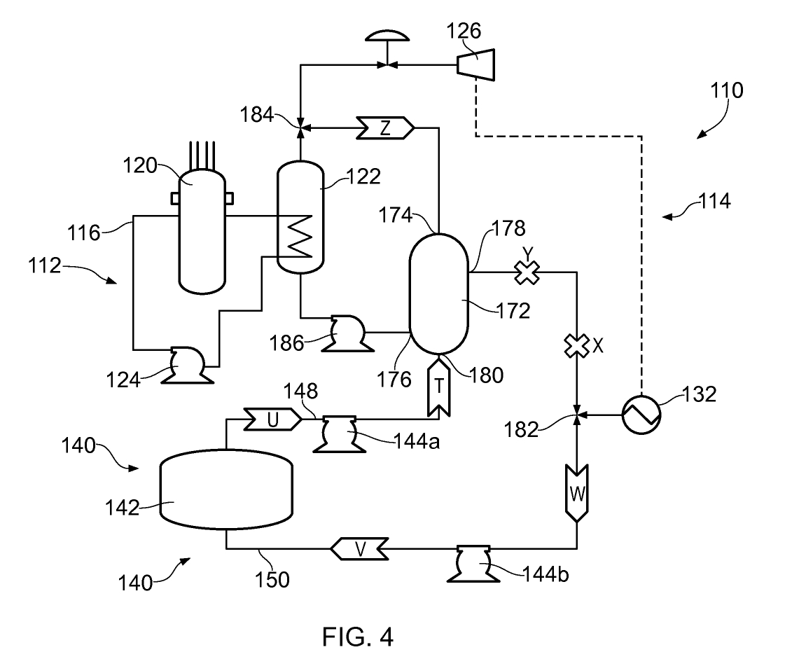

The operation of the energy storage system 140 during charging (i.e. when heat energy is stored) and discharging (i.e. when heat energy is provided to the heat exchanger) will now be described with reference to FIGS. 3 and 4.

Referring to FIG. 3, during charging, valve 184 is arranged so that at least a portion of the steam from the steam generator 122 is diverted to the saturator 172. The remainder of the steam from the steam generator is directed to the turbine 126 for energy production. The flow of steam from the steam generator 122 to the saturator 172 is indicated by arrow A.

The saturator 172 contains water that is cooler than the steam from the steam generator 122. Steam diverted from the steam generator enters the saturator via inlet 174. The steam and water contact/mix in the saturator so as to increase the temperature of the water in the saturator.

Heated fluid (e.g. water and/or steam) from the saturator exits the saturator 172 at the outlet 180, as is indicated by arrow B. The pump 144a is arranged so as to pump the fluid in a direction from the saturator to the vessel 142, and the fluid flows from the pump to the vessel as indicated by arrow C.

When the heated fluid enters the vessel 142, cooler water in the vessel flows from the vessel towards the saturator, as indicated by arrow D. Pump 144b is arranged as to pump the water exiting the vessel towards the saturator, as indicated by arrows E and F.

The valve arrangement 182 is operable to selectively allow water from the feedwater heater 132 to flow to the saturator, so as to maintain a steady flow rate in the system.

This process continues until the vessel 142 is charged with water that is below but close to saturation temperature.

During the charging process, heated water from the saturator 172 is supplied to the steam generator. That is, the inlet temperature of the steam generator is greater than would usually be expected in systems of the prior art.

Now referring to FIG. 4, during discharge pump 144a is operated in the opposite flow direction to that during charging, as such pump 144a pumps fluid from the vessel 142 to the saturator 172 as indicated by arrows T and U. The fluid from the vessel may be heated by steam from the steam generator so as to account for any temperature loss through the circuit, as indicated by arrow Z. Alternatively it will be appreciated that the steam generator could be supplied with fluid directly from the vessel 142.

During discharge, as indicated by crosses Y and X, flow of cooler water from the feed water heater to the saturator via inlet 178 is prevented using valve arrangement 182.

The pump 144b is operated in the opposite direction to the flow direction during charging, and as such is arranged to direct feed water from the feed water heater 132 to the vessel 142, as indicated by arrows W and V. The colder feed water enters the vessel 142 to replace the hotter water that has been directed to the steam generator.

Similar to the charging process, during the discharging process, heated water from the saturator 172 (or direct from the vessel 142) is supplied to the steam generator. That is, the inlet temperature of the steam generator is greater than would usually be expected in systems of the prior art.

The system 140 of FIG. 2 advantageously supplies fluid to the heat exchanger at a substantially constant temperature and pressure. This means that the reactor does not “see” the difference between charging and discharging and therefore the risk of reactor spikes is reduced.

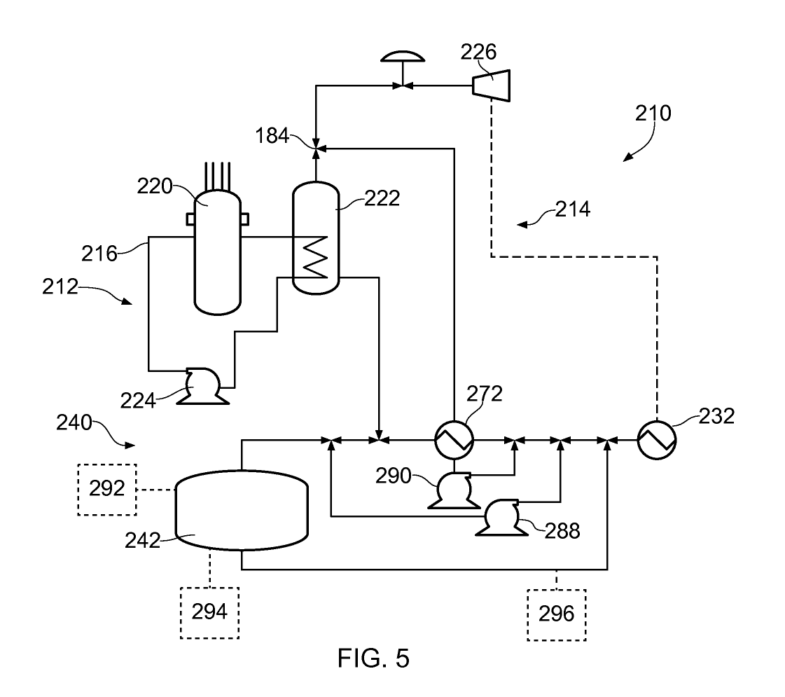

Referring now to FIG. 5, instead of using a direct saturator (as shown in FIGS. 2 to 4) an indirect saturator can be used. In the example shown in FIG. 5, the saturator 272 is a heat exchanger arranged to transfer heat from steam from the steam generator to water in the saturator.

During charging, steam flows from the steam generator 222 to the saturator 272. Heat is transferred in the saturator 272 from the steam to water flowing through the saturator. The heated water then flows to the vessel 242 for storage. Cooler water from the vessel 242 is displaced from the vessel 242 and flows to the saturator for heating. A plurality of valve arrangements are provided to control the flow direction of the fluid through the circuit. During charging, the pump 288 is not utilised and fluid is not directed through the conduits associated with the pump 288.

During discharging, the valve arrangement 284 is arranged to prevent flow from the steam generator 222 to the saturator 272. The other valve arrangements are arranged to reverse the direction of flow between the saturator and the vessel compared to charging the vessel. During charging water from the vessel is directed directly to the steam generator, and/or water is directed to the saturator via the pump 288 and then to the steam generator.

In this example, the valve arrangements define the flow direction in the circuit instead of using a bi-directional pumping arrangement. The pumps 288 and 290 are provided to balance the flow in the energy storage and secondary circuit.

It will be appreciated by one skilled in the art that, where technical features have been described in association with one or more embodiments, this does not preclude the combination or replacement with features from other embodiments where this is appropriate. Furthermore, equivalent modifications and variations will be apparent to those skilled in the art from this disclosure. Accordingly, the exemplary embodiments of the invention set forth above are considered to be illustrative and not limiting.

For example, instead of providing an inlet in the storage vessel for Nitrogen, so as to form a nitrogen blanket to account for the change in volume of fluid in the vessel at different temperatures, an overspill or a top-up tank may be provided. Example tanks and tank positions are indicated by dotted boxes in FIG. 5. As is understood in the art, when a fluid is heated the volume of the fluid increases and as it is cooled the volume of the fluid decreases (when at the same pressure). To accommodate this change in volume an overflow tank 292 may be provided to store heated fluid that cannot be accommodated in the vessel 242. Alternatively, a top-up tank 294 may be provided to fill the vessel with cold water to account for the change in volume when the vessel contains relatively colder water. The top-up tank may be supplied with fluid from the feed heater 232. The top-up tank 294 is in direct fluid communication with the vessel, but the top-up tank may be positioned at any suitable location, for example tank 296 may be used.

The storage vessel has been described as a spherical vessel, but in alternative embodiments the storage vessel may be of any suitable shape and construction, e.g. the storage vessel may be a cylindrical pressure vessel.

In the described embodiments the storage vessel is configured to store fluid at a pressure substantially equal to the pressure of the secondary fluid in the steam generator. However, in alternative embodiments the vessel may not be a pressure vessel or may not be arranged to operate as such high pressures. For example, the energy storage system may comprise a heat exchanger. The heat exchanger may transfer heat from the secondary fluid to a tertiary fluid. The tertiary fluid may have a higher boiling point than the secondary fluid, for example the tertiary fluid may be a molten salt.

The steam generator has been described as a single steam generator, but in alternative embodiments a plurality of steam generators may be associated with a single nuclear power plant. A single pressure vessel has been described but in alternative embodiments a plurality of pressure vessels may be associated with a single energy storage system.

The energy storage system has been described for use as part of a nuclear power plant, but in alternative embodiments the storage system may be utilised in other energy generation applications. For example, the storage system may be connected to a solar power plant.

1. An energy storage system for regulating power output of a power generation plant that has a heat exchanger, a primary circuit and a secondary circuit, the primary circuit directs a primary fluid flow to components of a primary region and the secondary circuit directs a secondary fluid flow to components of a secondary region, and the heat exchanger is arranged so that the secondary fluid flow is heated from the primary fluid flow, the energy storage arrangement comprising:
a vessel;
a fluid transfer arrangement connected to the vessel and connectable to the heat exchanger of the power generation system so as to arrange the fluid transfer arrangement in fluid communication with the heat exchanger and the vessel; and
a bidirectional flow arrangement configured to control a flow direction of fluid between the vessel and the fluid transfer arrangement so as to selectively store heat energy from secondary fluid exiting the heat exchanger in the vessel, and to selectively transfer heat energy stored in the vessel to the heat exchanger.

2. The energy storage system according to claim 1, wherein the fluid transfer arrangement includes a saturator for transferring heat energy from the secondary fluid exiting the heat exchanger to secondary fluid at a lower temperature than the fluid exiting the heat exchanger, and/or for transferring heat energy from secondary fluid stored in the vessel to a secondary fluid at a lower temperature than the fluid stored in the vessel.

3. The energy storage system according to claim 2, wherein the saturator includes a tank having a first inlet for receiving secondary fluid at a lower temperature than the fluid exiting the heat exchanger, and a second inlet for receiving secondary fluid exiting the heat exchanger, and wherein the tank is arranged so that the fluid from the heat exchanger can directly contact the lower temperature fluid.

4. The energy storage system according to claim 2, wherein the saturator includes a heat exchanger defining a first fluid pathway for receiving fluid at a lower temperature than the fluid exiting the heat exchanger and a second fluid pathway for receiving secondary fluid from the heat exchanger, the first fluid pathway being positioned adjacent the second fluid pathway.

5. The energy storage system according to claim 2, wherein the bidirectional flow arrangement is configured so as to selectively direct fluid from the vessel directly to the heat exchanger and/or to selectively direct fluid from the vessel to the saturator to heat a fluid to be directed to the heat exchanger.

6. The energy storage system according to claim 2, wherein the bidirectional flow arrangement is a bidirectional pumping arrangement provided between the saturator and the vessel.

7. The energy storage system according to claim 6, wherein a conduit is provided between the saturator and the vessel and a first two-way pump is positioned along said conduit, and a further conduit is provided between the saturator and the vessel and a second two-way pump is positioned along said further conduit.

8. The energy storage system according to claim 2, wherein the direction of flow is controlled using a plurality of valves.

9. The energy storage system according to claim 2, wherein a valve arrangement is provided to control the volume of fluid flow from the heat exchanger of the power plant to the saturator.

10. The energy storage system according to claim 1 comprising a first conduit connected to the vessel and connectable to the heat exchanger of the power generation system so as to arrange the vessel in fluid communication with the heat exchanger.

11. The system according to claim 10, comprising a second conduit connected to the vessel and connectable to the secondary circuit at a position upstream of the heat exchanger so as to arrange the vessel in fluid communication with the secondary circuit.

12. The system according to claim 1, wherein the vessel includes a baffle that in use limits mixing of hotter fluid in the vessel with cooler fluid in the vessel.

13. The system according to claim 12, wherein the baffle includes a serpentine path along which secondary fluid can flow in the vessel.

14. The system according to claim 1, wherein the vessel is a pressurised vessel capable of containing fluid at a pressure greater than or equal to 50 bar.

15. An energy storage system for regulating power output of a power generation plant that has a heat exchanger, a primary circuit and a secondary circuit, the primary circuit directs a primary fluid flow to components of a primary region and the secondary circuit directs a secondary fluid flow to components of a secondary region, and the heat exchanger is arranged so that the secondary fluid flow is heated from the primary fluid flow, the energy storage arrangement comprising:
a vessel;
a fluid circuit connected to the vessel and connectable to the heat exchanger, wherein the fluid circuit comprises a saturator for transferring heat energy from one fluid to another; and
wherein the fluid circuit is configured to direct fluid exiting the heat exchanger to the saturator, direct fluid from the saturator to an inlet of the heat exchanger, to direct fluid flow to the vessel from the saturator, and to direct fluid flow to the saturator and/or the heat exchanger from the vessel.

16. A nuclear power plant comprising:
a reactor;
a primary fluid flow for cooling the reactor;
a steam generator;
a secondary fluid flow that is heated by the primary fluid flow in the steam generator;
a power generator powered by the secondary fluid heated in the steam generator; and
an energy storage system according to claim 1.

17. A method of modifying the power output of a power generation system, the power generation system comprising a heat exchanger for heating a secondary fluid from a primary fluid, the method comprising:
selectively diverting a portion of the secondary fluid exiting the heat exchanger to an energy storage system,
storing the secondary fluid from the heat exchanger in a vessel, or using the secondary fluid from the heat exchanger to heat a fluid that is then stored in a vessel.

18. The method according to claim 17, comprising selectively diverting fluid from the vessel to the heat exchanger, or using fluid from the vessel to heat a fluid that is then diverted to the heat exchanger.

19. The method according to claim 17, wherein the heat exchanger is a steam generator and the fluid in the vessel is at a similar pressure to the secondary fluid in the steam generator.

20. The method according to claim 17, wherein the fluid is stored in the vessel at saturation pressure and temperature.
